(19) United States
(12) Patent Application Publication
(10) Pub. No.: US 2006/0274439 A1
(43) Pub. Date: Dec. 7, 2006

(54) Optical system using tailored imaging designs

(76) Inventors: Jeffrey M. Gordon, Midreshet Ben-Gurion (IL); Daniel Feuermann, Midreshet Ben-Gurion (IL); Stephen John Horne, El Granada, CA (US); Gary D. Conley, Saratoga, CA (US)

Correspondence Address: DORITY & MANNING, P.A., POST OFFICE BOX 1449, GREENVILLE, SC, 29602-1449, US

(21) Appl. No.: 11/351,314

(22) Filed: Feb. 9, 2006

Related U.S. Application Data
(60) Provisional application No. 60/651,856, filed on Feb. 10, 2005.

(51) Int. Cl. G02B 5/10

(52) U.S. Cl. 359/859

(57) ABSTRACT

Ultra-compact concentrators and illuminators that approach the thermodynamic limit to optical performance can be realized with purely imaging strategies. Two-stage reflector systems where each optical surface is tailored to eliminate one order of aberration—so-called aplantic designs are described. The contours are monotonic functions that can be expressed analytically—important in facilitating optimization studies and practical fabrication. The radiative performance of the devices presented herein is competitive with, and even superior to, that of high-flux nonimaging systems. Sample results of practical value in solar concentration and light collimation are presented for systems that cover a wide range of numerical aperture.

### RELATED APPLICATIONS

The present application is based upon and claims priority to U.S. Provisional Patent Application No. 60/651,856, filed on Feb. 10, 2005.

### BACKGROUND OF THE INVENTION

Concentrators and illuminators capable of approaching the thermodynamic limit to radiative transfer have commonly been regarded within the realm of nonimaging optics. The alternative of a purely imaging strategy in which each of two mirrored contours is tailored to eliminate one order of aberration has been investigated.

The elimination of an order of geometric aberration provides a degree of freedom for tailoring an optical surface. For example, a paraboloidal reflector or a plano-convex lens removes zeroth-order (spherical) aberration. If two surfaces may be tailored, then both zeroth- and first-order (comatic) aberration can be overcome (referred to as aplantic). Whereas high definition, high-f-number imaging systems have incorporated aplanatic devices, the value of such double-tailored systems for radiation concentration or collimation has remained unexplored.

Nonimaging optical designs are typically not compact and do not accommodate a large gap at the receiver, unless a significant loss in either efficiency or concentration is incurred. Common parabolic and Cassegrain designs can also have various drawbacks and deficiencies. For example, high-f-number systems exhibit small aberrations, but require large aspect ratios and generate low flux. While compactness and high flux can be achieved with Cassegrains, they incur excessive shading. Thus, a need currently exists for a concentrator and/or illuminator that is capable of being ultra compact, that can create a relatively high concentration at high collection efficiency, that may allow a sizeable gap between an absorber and the mirrors, that has an upward facing absorber, and that can obviate chromatic aberrations.

In this regard, the present disclosure is generally directed to imaging reflector strategies that may overcome some of the drawbacks and deficiencies of prior art constructions.

### SUMMARY

In view of the recognized features encountered in the prior art and addressed by the present subject matter, an improved optical system using tailored imaging designs has been developed. Such new class of optical design provides a relatively compact system that can achieve radiative performance that is competitive with, and even superior to in some embodiments, that of high-flux nonimaging systems.

In some exemplary optical system embodiments of the present invention, a design is achieved that can be relatively easy to build and assemble. Furthermore, the design may potentially be subjected to significant mechanical misalignment while still operating with effective concentration levels.

In one exemplary embodiment of the present subject matter, an imaging optical system (such as but not limited to one that functions to concentrate radiation) includes a primary reflective surface having a first shape described by:

a) radial coordinate R_{P}:
R_{P}=2T/(1+T²)

b) axial coordinate X_{P}:
X_{P}=s−(1/(1+T²))+((s−(1−s)T²)(1−Kg(T)))/(s(1+T²)²); and
a secondary reflective surface having a second shape described by:

a) radial coordinate R_{S}:
R_{S}=(2sKTg(T))/(s−(1−s)T²+KT²g(T))

b) axial coordinate X_{S}:
X_{S}=−(sK(1−T²)g(T))/(s−(1−s)T²+KT²g(T))

wherein T=tan(φ/2), g(T)=|1−((1−s)T²/s)|^{-s/(1-s)}, φ is the angle between the optical axis and a light ray extending between the focus of the optical system and the secondary reflective surface when the light ray forms the largest cone of meridional rays that can enter or leave the system, s is the distance between the apex of the primary reflective surface and the apex of the secondary reflective surface, and K is the distance between the focus and the apex of the secondary reflective surface.

More particular embodiments of the above imaging optical system may be configured such that the focus is substantially coincident with the apex of the primary reflective surface. In another exemplary embodiment, the focus is between the primary and secondary reflective surfaces. In yet another exemplary embodiment, the focus is behind or below the primary reflective surface in relation to the secondary reflective surface.

In other more particular embodiments of the present subject matter, an imaging optical system is further characterized in that the primary reflective surface has a first rim and the secondary reflective surface has a top surface defining either a rim of the secondary reflective surface or the apex of the secondary reflective surface. In one embodiment, the top surface of the secondary reflective surface may be substantially coplanar with the rim of the primary reflective surface. For example, if the secondary reflective surface has a convex shape, the rim of the secondary reflective surface can be substantially coplanar with the rim of the primary reflective surface. If the secondary reflective surface, on the other hand, has a concave shape, then the apex of the secondary reflective surface can be substantially coplanar with the rim of the primary reflective surface. It should be understood, however, that in other embodiments the reflective surfaces need not be substantially coplanar.

The optical system of the present disclosure can have various and sundry applications and uses. In one embodiment, for instance, the optical system may be used to concentrate radiation contacting the system. In this embodiment, for instance, the concentrated radiation may be used to produce electrical power. For example, the imaging optical system may be incorporated into a solar cell.

Alternatively, the optical system can be used in an illuminating device. In this embodiment, the optical system can surround a light source for emitting collimated radiation.

In one exemplary embodiment, for example, when the imaging optical system is used to concentrate radiation striking the system, the imaging optical system may include a radiation conduit (such as but not limited to an optical rod or an optical fiber), wherein the imaging optical system has a focus, and wherein the focus is substantially at an entrance to the radiation conduit. Still further exemplary imaging optical system embodiments further include an energy conversion device, such as but not limited to a photovoltaic cell that is placed in communication with radiation conduit.

When the imaging optical system of the present disclosure is used in an illuminating device, the optical system may be configured to collimate radiation. For example, a light source may be placed at the focus of the system. The light source may comprise, for instance, a quasi-lambertian source, such as a light-emitting diode. In this embodiment, the light source may be connected to a power supply. The power supply may comprise, for instance, one or more batteries or any other suitable power source.

Additional objects and advantages of the present subject matter are set forth in, or will be apparent to, those of ordinary skill in the art from the detailed description herein. Also, it should be further appreciated that modifications and variations to the specifically illustrated, referred and discussed features and steps hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures).

Additional embodiments of the present subject matter, not necessarily expressed in this summarized section, may include and incorporate various combinations of aspects of features, components, or steps referenced in the summarized objectives above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 provides a cross-sectional illustration of an exemplary concentrator design in accordance with aspects of the present invention;

FIG. 2 provides a cross-sectional illustration of an exemplary design for converging complementary devices (here with NA₂=0.5), as compared to the exemplary design presented in FIG. 1;

FIG. 3 provides an exemplary tailored imaging concentrator designed for NA₂=0.50, wherein the absorber is sited in the focal plane (the solid dot indicates the focus), and flux maps are plotted for a range of NA₁ values;

FIGS. 4a, 4b and 4c respectively provide sample tailored imaging concentrators and their efficiency-concentration curves;

FIG. 5 provides exemplary flux maps when the design of FIG. 4b is deployed as a collimator, wherein Intensity I is scaled such that ∫I(θ)d(sin²(θ)) equals the efficiency; and

FIG. 6 provides an illustration of exemplary collimation performance for an optical system where the actual source has NA₂=0.46, but the illuminator is lightly over-designed for NA₂=0.50. The intended collimation is NA₁=0.010, and the upper and lower drawings pertain to near- and far-field targets, respectively.

Repeat use of reference characters throughout the present specification and appended drawings is intended to represent same or analogous features or elements of the present invention.

### DETAILED DESCRIPTION OF THE PREFERRED EMBODIMENTS

Select combinations of the disclosed aspects of the present invention correspond to a plurality of different embodiments of the present technology. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function. Similarly, certain process steps may be interchanged or employed in combination with other steps to yield additional exemplary embodiments of the present subject matter.

Reference will now be made in detail to the presently preferred embodiments of the subject optical system. In general, the present disclosure is directed to an optical system that may be used to receive and concentrate radiation or may be used to collimate and emit radiation. When used to receive radiation, such as radiation emitted by the sun, the optical system may be integrated into, for instance, a solar cell. Solar cells are designed to directly convert radiation into electricity. For instance, in one embodiment, a solar cell may include a semiconductor device consisting of a single p-n junction cell or a p-n multi-junction cell, which in the presence of sunlight is capable of generating useable energy. Specifically, the semiconductor material may exhibit a photoelectric effect that causes the material to absorb photons of light and release electrons. The released electrons form a current that can be used as electricity. When incorporated into a solar cell, the optical system may be placed in communication with a photovoltaic cell that receives the concentrated radiation.

As described above, the optical system of the present disclosure may also be used to emit radiation. For instance, the optical system may be incorporated into any suitable illumination device. In this embodiment, the optical system surrounds or is in communication with a light source connected to a power source. The light source emits light rays that are then collimated by the optical system.

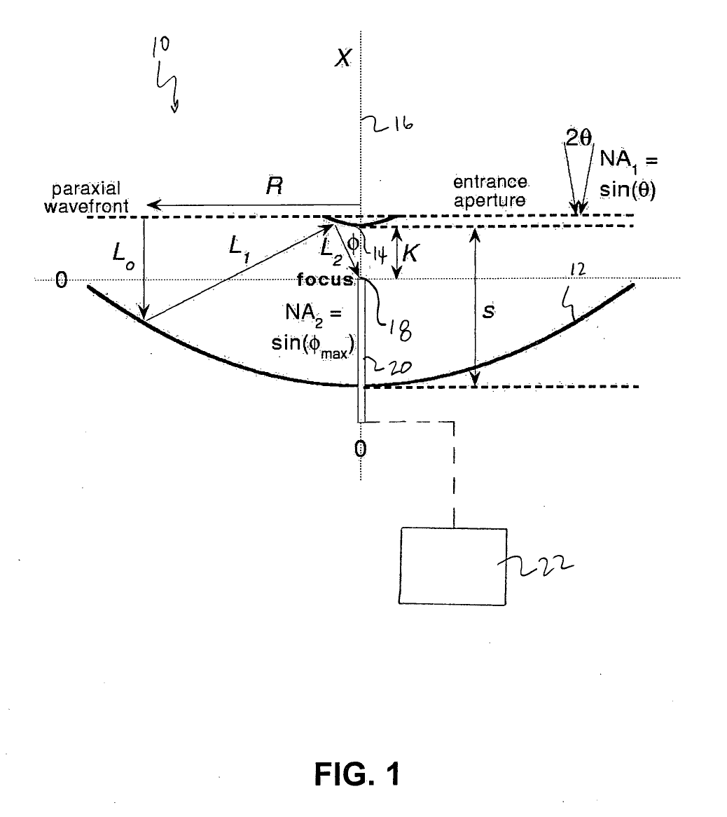

One embodiment of an optical system made in accordance with the present disclosure is shown in FIG. 1. As shown, the optical system 10 includes a primary reflective surface 12 positioned in relation to a secondary reflective surface 14. In this embodiment, the primary reflective surface 12 has a concave shape, while the secondary reflective surface 14 has a convex shape. The primary reflective surface 12 and the secondary reflective surface 14 can be made from any suitable material capable of reflecting radiation. For instance, in one embodiment, the surfaces 12 and 14 may comprise polished mirrors.

As shown in FIG. 1, in this embodiment, the primary reflective surface 12 and the secondary reflective surface 14 are axisymmetric. In particular, both reflective surfaces 12 and 14 share a common axis or vertex 16. As will be described in more detail below, the primary reflective surface 12 is spaced in relation to the secondary reflective surface 14 so as to form a focus 18.

When used to concentrate radiation that is received by the optical system 10, the optical system can include an entrance numerical aperture NA, onto a flat single-sided absorber with an exit numerical aperture NA₂. In general, a numerical aperture refers to the sine of the vertex angle or half angle of the largest cone of meridional rays that can enter or leave an optical system or element, multiplied by the refractive index of the medium in which the vertex of the cone is located. For most applications, the medium is air which has a refractive index of one. The numerical aperture is also sometimes referred to as one-half the angular aperture.

As shown in FIG. 1, NA₁=sin(θ). When the optical system is used to receive radiation, for instance, θ represents one-half the angle from the optical system to the sun. In some embodiments, there may be benefits and advantages to artificially increasing θ. For instance, in one embodiment, θ can be from about 3 degrees to about 20 degrees, such as from about 5 degrees to about 10 degrees greater than the actual angle between the optical device and the sun.

As shown in FIG. 1, NA₂=sin(φₘₐₓ). φₘₐₓ is the angle between the optical axis (line X-O) and a light ray extending between the focus and the secondary reflective surface when the light ray forms the largest cone of meridional rays that can enter or leave the optical system. In other words, φₘₐₓ is the angle at which a light ray reaches the focus when entering the optical system from the outermost edge of the primary reflective surface.

In one embodiment, the mirror contours as shown in FIG. 1, may be tailored such that (a) all paraxial rays are focused, and (b) the Abbe sine condition is satisfied. Irradiation from the actual extended far-field source has NA₁=sin(θ), to be concentrated onto an extended, upward-facing disc, depicted here as the entrance to an equi-diameter light guide. In illumination mode, on the other hand, light emitted over NA₂ from a point focus would emerge perfectly collimated; but the actual illuminator has an extended source and emits over NA₁. The constrained thermodynamic limit to flux concentration is
Cₘₐₓ=(NA₂/NA₁)². (1)
Therefore the absorber diameter in some exemplary embodiments should not be less than
dₘᵢₙ=D(NA₁/NA₂) (2)
where D denotes the entrance diameter. Larger absorber diameters can raise collection efficiency, but at the expense of diminished average flux concentration. This fundamental tradeoff between concentration and collection efficiency is quantified below for an assortment of tailored imaging designs. In accordance with the present disclosure, the primary reflective surface 12 and the secondary reflective surface 14 may be designed and positioned relative to one another so as to maximize concentration in conjunction with collection efficiency depending upon the particular application.

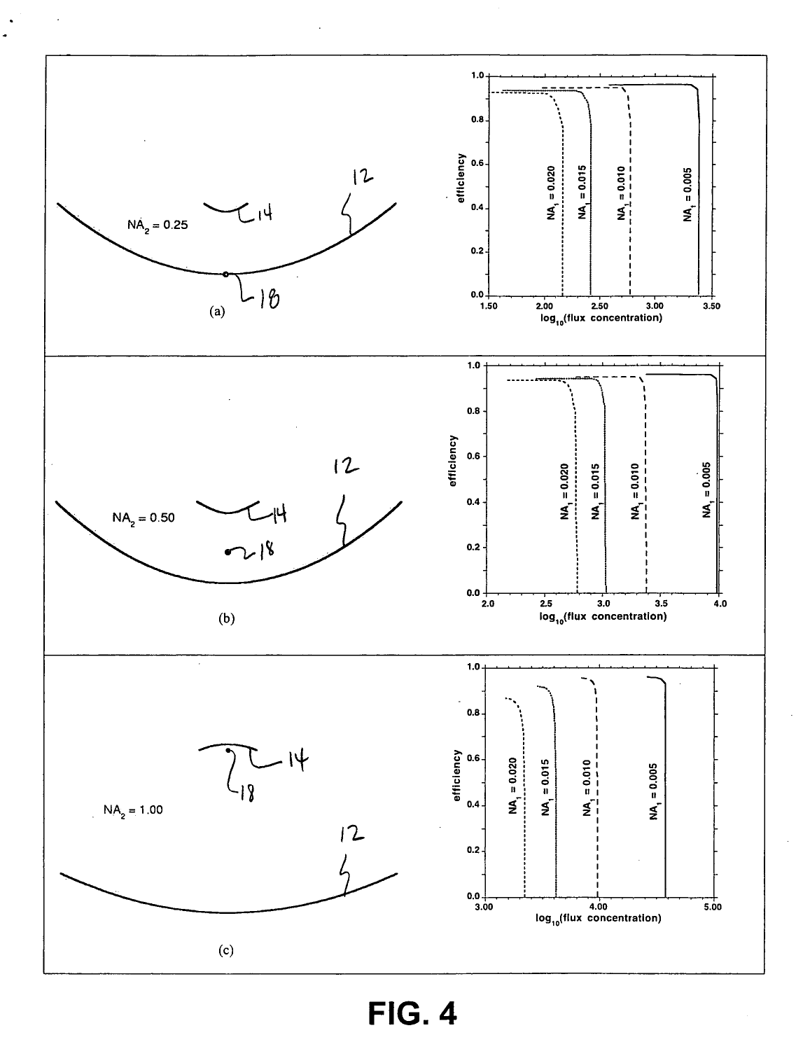

Satisfying (a) Fermat's constant-string-length prescription and (b) Abbe's sine condition, constitutes the correction for zeroth- and first-order aberrations, respectively:
L₀+L₁+L₂=constant (3)
R=(constant′)sin(φ) (4)
where L denotes string length, R is the radial coordinate at the entrance aperture, and φ is the angle at which a ray reaches the focus (NA₂=sin(φₘₐₓ), established by the extreme ray from the primary mirror's rim. L₀, L₁, L₂, and φ are all diagrammatically illustrated in FIG. 1. The focus is selected as the origin of the coordinate system. The optical system can be configured so that the focus can be positioned at various locations. For instance, the focus can be positioned in between the primary reflective surface 12 and the secondary reflective surface 14 as shown in FIG. 1. Alternatively, the focus can be positioned at the apex of the primary reflective surface 12 as shown in FIG. 4A. In still another embodiment, the focus can be positioned behind the apex of the primary reflective surface 12 when NA₂ is sufficiently low.

In order to design an optical system in accordance with the present disclosure, two geometric parameters can first be specified as follows:

a) the distance between the apex of the primary reflective surface 12 and the apex of the secondary reflective surface 14 denoted “s” in FIG. 1; and

b) the distance between the focus 18 and the apex of the secondary reflective surface 14 is also shown in FIG. 1 and which is denoted “K”. In order to mathematically design the system of the present disclosure, Snell's Law of reflection (a differential equation) is then used.

Solving these coupled equations analytically produces the parametric solution for the axial (X) and radial (R) coordinates for the primary (subscript p) and secondary (subscript s) shapes as follows:

$${R}_{p} = \frac{2 T}{1 + {T}^{2}} \\ {X}_{p} = s - \frac{1}{1 + {T}^{2}} + \frac{( s - ( 1 - s ) {T}^{2} ( 1 - Kg ( T ) )}{{s ( 1 + {T}^{2} )}^{2}} \\ {R}_{s} = \frac{2 sKTg ( T )}{s - ( 1 - s ) {T}^{2} + {KT}^{ 2} g ( T )} \\ {X}_{s} = - \frac{sK ( 1 - {T}^{2} ) g ( T )}{s - ( 1 - s ) {T}^{2} + {KT}^{ 2} g ( T )} \\ where T = tan ( ϕ / 2 ) and g ( T ) = {\vert 1 - \frac{( 1 - s ) {T}^{2}}{s} \vert}^{\frac{- s}{1 - s}} . \qquad ( 5 )$$

The above equations set the shape and spacial relationship between the primary reflective surface and the secondary reflective surface. The radius of the primary reflective surface is NA₂. Eq (5) is the solution on one side of the optic axis; the other half is its mirror image. As can be appreciated, the above equations can yield many different designs. Some designs, however, may operate more efficiently than others. For instance, one should take into account blocking losses and shading losses. For instance, as shown in FIG. 1, the optical system can include a radiation conduit 20. The radiation conduit 20 has an entrance positioned at the focus 18. The radiation conduit 20 is for directing the concentrated radiation to a power generation device 22, such as a photovoltaic cell. Blocking losses may occur when light rays reflected from the primary reflective surface 12 strike the radiation conduit 20.

Shading losses, on the other hand, occur when the secondary reflective surface 14 blocks radiation from being received by the primary reflective surface 12. In some embodiments, for instance, the optical system 10 can be designed such that the secondary reflective surface 14 blocks less than 10% of the area of the primary reflective surface 12, such as less than about 6% of the primary reflective surface area 12, and, in one embodiment, blocks less than about 3% of the surface area of the primary reflective surface 12.

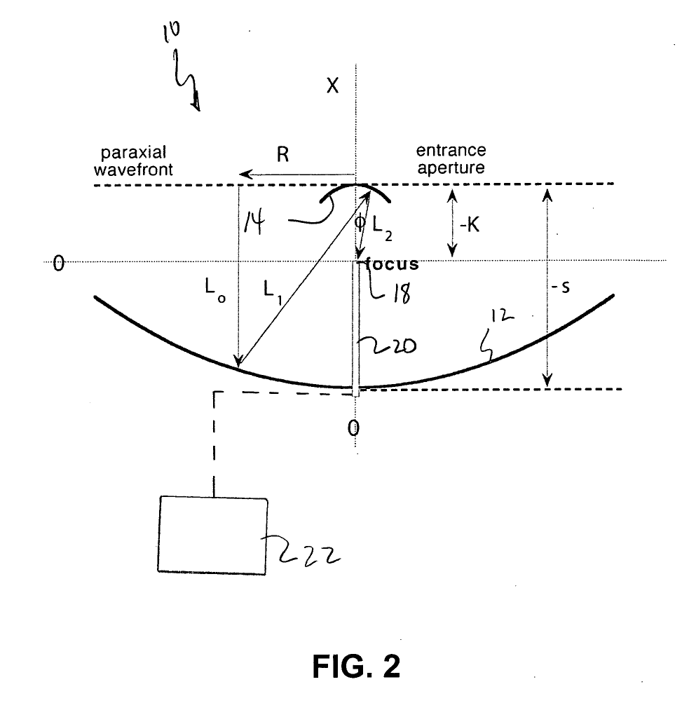

The analysis above comprises a diverging optical system, i.e., the caustic of rays from the primary resides behind the secondary. There is also a second class of complementary converging solutions, where the caustic lies between the primary and secondary (and the secondary is always concave). The solution of Eq (5) is the same, but with negative values for the geometric input parameters. For instance, referring to FIG. 2, an alternative embodiment of an optical system generally 10 made in accordance with the present disclosure is illustrated. Like reference numerals have been used to indicate similar elements. As shown, in this embodiment, the secondary reflective surface 14 is concave in shape and is positioned above the primary reflective surface 12. The negative values for s and K are shown.

In FIG. 2, a radiation conduit 20 is also shown. As described above, the radiation conduit 20 is for receiving the concentrated radiation and delivering the radiation to an energy conversion device, such as a photovoltaic cell 22. The radiation conduit 20 can have any suitable shape and can be made from any suitable material. For instance, in one embodiment, the radiation conduit may be made from an optical rod or an optical fiber. The entrance to the radiation conduit is placed substantially at the location of the focus 18. In one embodiment, the radiation conduit can have a cone-shaped entrance such that the entrance has a larger diameter than the remainder of the conduit.

In addition to receiving and concentrating radiation, the optical systems of the present disclosure are also well suited for use in illumination devices as will be described in more detail below.

When designing the system to receive and concentrate radiation in accordance with the present disclosure, several different scenarios can result in losses and, in some applications, may therefore be avoided:

(a) the caustic of rays from the primary can occupy the vicinity of the exterior of the secondary, so that rays from the primary strike the outside of the secondary—exceedingly so for compact units and high NA₂;

(b) the secondary can fall below the entrance aperture of the primary, in which case a significant fraction of rays from the primary is lost on the exterior of the secondary;

(c) as NA₂→1, the overlap between the bottom of the absorber and the caustic can produce considerable blocking.

Because converging solutions enjoy neither (1) any practical or flux performance advantage, nor (2) greater tolerance to optical errors, the examples below are restricted to diverging solutions.

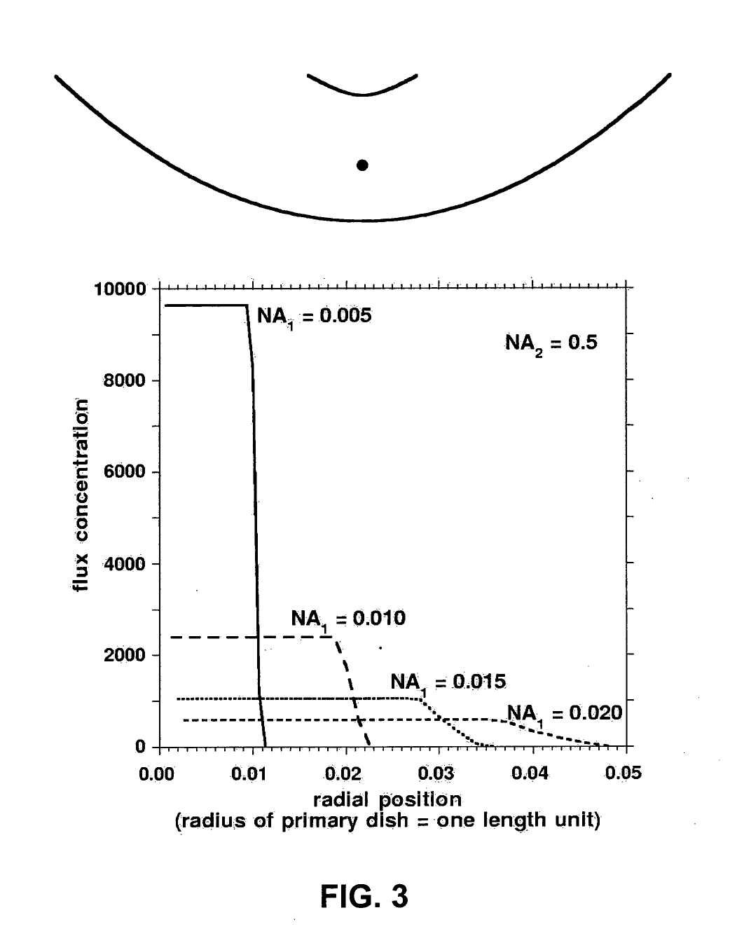

Optical performance was ascertained with simulations in which 250,000 rays distributed uniformly both spatially and in solid angle were traced, with a top-hat angular input distribution. Results are summarized as flux maps, for a particular concentrator with varying NA₁ values. For example, as shown in FIG. 3, a graph is illustrated comparing radial position to flux concentration as the numerical aperture NA₁ varies, while the second numerical aperture NA₂ remains constant at 0.5. To avoid ambiguity in the length scale for the different cases in FIG. 3, the radius of each primary dish is defined as unity. A representative illustration of the optical system tested in FIG. 3 is also shown above the graph.

As shown in FIG. 3, when the second numerical aperture is 0.5, flux concentration generally increases as the first numerical aperture decreases. Thus, for many applications, the first numerical aperture can be from about 0.005 to about 0.1, such as from about 0.01 to about 0.005, such as from about 0.02 to about 0.005.

Characteristic plots of efficiency against concentration follow from flux map integration. For instance, such characteristic plots are shown in FIGS. 4a, 4b and 4c. Efficiency remains less than unity even in the low-concentration regime due to ray rejection and shading. Absorption in the (specular) reflectors is not included but readily estimated as 1−ρ² (ρ=reflectivity) since each ray experiences exactly two reflections. Fresnel reflections from the absorber are also not accounted for since they are material-specific and easily quantified.

NA₁ represents the convolution of the actual source size with optical errors. With solar concentrators in mind, raytrace simulations were performed for NA₁≧0.005, because the solar disc subtends an angular radius of 0.0047 rad, and optical errors commensurate with NA₁=0.005 are experimentally attainable. The largest NA₁ value of 0.020 subsumes liberal errors in mirror contour and alignment.

No special significance should be attached to the NA₂ values chosen for FIG. 4 (except in FIG. 4c toward demonstrating that practical devices are possible at the ultimate flux limit of NA₂=1.00). The embodiments illustrated in FIGS. 4a and 4b represent embodiments of optical systems where many of the objectives described above are satisfied. In both FIGS. 4a and 4b, the secondary reflective surface 14 has a convex shape. In FIG. 4a, the focus 18 is positioned at the apex of the primary reflective surface 12. In FIG. 4b, on the other hand, the focus 18 is positioned in between the primary reflective surface 12 and the secondary reflective surface 14.

Of particular advantage in the embodiments shown in FIGS. 4a and 4b is that the rim of the primary reflective surface 12 and the rim of the secondary reflective surface 14 are coplanar. Having the primary reflective surface and the secondary reflective surface be coplanar along their top surfaces may provide various manufacturing advantages. For instance, when incorporated into a solar cell, a solar module, or a solar array, the reflective devices may need to be attached to a supporting structure, such as a transparent or translucent plate. The plate, for instance, may be made from glass or any suitable plastic. By being coplanar, the primary reflective surface and the secondary reflective surface may be attached to a surface of the plate for facilitating assembly.

The embodiments illustrated in FIGS. 4a and 4b may provide other various advantages. For instance, the optical systems illustrated accommodate optical tolerances of affordable manufacturing procedures, as well as net flux concentration values in the range of 300-2000 suns. Another advantage is that the optical systems can be made ultra compact. For instance, the optical systems can have an aspect ratio of close to 1:4, meaning that the diameter of the primary reflective surface 12 can be approximately four times the depth of the system.

The actual size of the primary reflective surface 12 and the secondary reflective surface 14 can vary dramatically depending upon the particular application and the desired results. For compact solar cells, for instance, the secondary reflective surface may have a diameter of from about 3 mm to about 100 mm, while the primary reflective surface may have a diameter of from about 10 mm to about 1000 mm. In other systems, however, the sizes of the reflective surfaces may be much greater. For instance, the diameter of the secondary reflective surfaces may easily exceed 1000 mm.

In FIG. 3 and in FIG. 4b, the optical system is coplanar and compact. The focus 18 is positioned above the apex of the primary reflective surface 12 is order to avoid shading losses as described above. In FIG. 4a, on the other hand, the focus 18 can be placed at the apex of the primary reflective surface 12 while also avoiding shading losses.

The optical performance of imaging concentrators can worsen as NA₁ grows and higher-order aberrations are magnified. The sensitivity to NA₂ and to compactness is subtler. As NA₂ is raised, it becomes increasingly difficult to realize compact configurations without introducing excessive shading or ray rejection. Deeper concentrators tend to be more tolerant to larger NA₁. Similarly, a larger secondary reduces the sensitivity to NA₁, but at the expense of greater shading.

Efficiency-concentration relations for tailored imaging designs are superior to those of corresponding conventional imaging devices. This would appear to derive from the dependence of aberrations on f-number (f). First-order aberration is proportional to f², whereas second-order aberration is proportional to 1/f. It also explains why the most compact tailored imaging concentrators with low shading are least tolerant to increasing NA₁.

As described above, the optical system of the present disclosure may also be used in conjunction with an illumination device for emitting a collimated light beam. In an illumination mode, a light source is placed at the focus 18. Referring to FIG. 1, for instance, in illumination mode the photovoltaic cell 22 comprises a power source that is in electrical communication with the light source positioned at the focus. In general, any suitable light source may be placed within the system. The light source may comprise, for instance, any suitable light bulb. In one particular embodiment, a quasi-lambertian source emitting over NA₂ sits at the focus. Collimation is required over a nominal NA₁ (at high efficiency). NA₁ for the actual illuminator comprises the convolution of (a) the extended source with (b) optical errors. The source can, for example, be an optical fiber or a light-emitting diode, and can be sized based on the prescribed NA₁, with the minimum source size following from the restricted thermodynamic limit (Eq (2)).

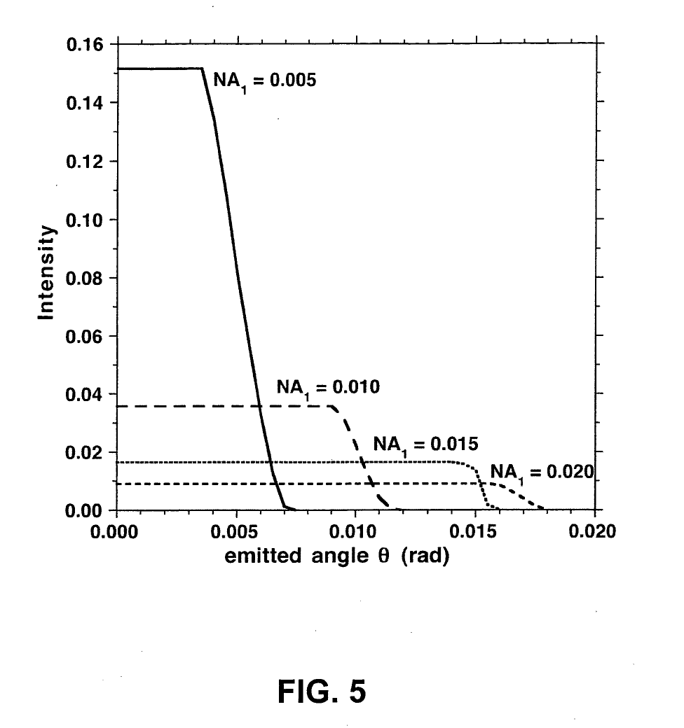

The design of FIG. 4b (in illumination mode) offers an illustrative example. The flux maps of FIG. 5 summarize the raytrace results. The angular dependence of irradiance is the same at near- and far-field here because the distinguishing factor of cos⁴(θ) for far-field illuminance is essentially unity (NA₁≦0.020). The resemblance between flux maps in concentrator and collimator mode follows from the relation between concentrator acceptance-angle function and collimator far-field illuminance.

Radiative losses, however, can stem from:

(1) trapped rays that either exit through the apex region of the primary or are reflected to the base of the source (analogous to shading losses in concentrators);

(2) off-axis rays from the periphery of the source that miss the secondary (zero-reflection emissions); and

(3) off-axis rays reflected to large emission angles.

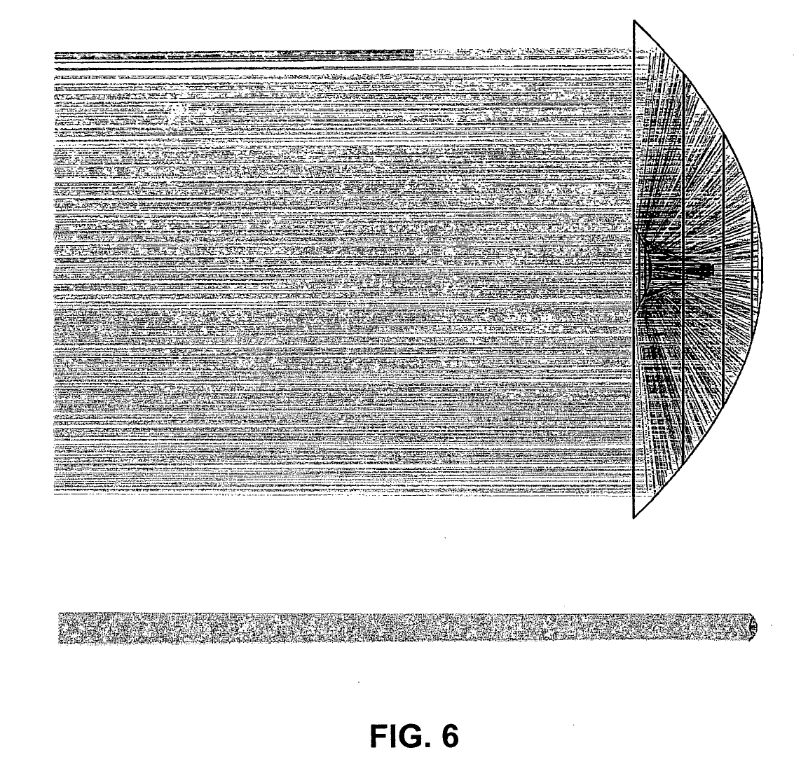

The latter two categories can be decreased by modest over-design, e.g., by slightly increasing the design value of NA₂ relative to the NA₂ of the actual light source. The raytrace results portrayed in FIG. 6 relate to a collimator with a moderate over-design: the actual source possesses NA₂=0.46 but the design is for NA₂=0.50, with a target collimation NA₁=0.010.

As shown above, purely imaging two-stage concentrators and illuminators can provide radiative transfer at the thermodynamic limit. Their mirror contours are tailored to eliminate zeroth- and first-order aberrations, in devices devoid of chromatic aberration. When the NA of far-field sources or targets does not exceed around 0.02, these aplanatic systems can outperform even the best nonimaging counterparts. Their practical virtues include ultra compactness (aspect ratios close to ¼), and the ability to accommodate a large gap between the focus and the mirrors. The reflector shapes are monotonic functions that can be expressed analytically—important in both tenable optimization studies and affordable manufacturing procedures. Case studies that cover a wide range of NA reveal both the robustness and limitations of such devices.

Whereas the devices analyzed herein are axisymmetric, optical systems may require different shapes for the absorber and/or entrance aperture. Flux uniformity may also be a consideration. Solutions are available for such modifications in geometry, and range from (a) light guides that accommodate the geometric conversion, albeit at a dilution in concentration, to (b) microgroove structures that achieve the shape conversion at minimal reduction in flux.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An imaging optical system comprising:
a primary reflective surface having a an apex and first shape described by:
a) radial coordinate R_{P}:
R_{P}=2T/(1+T²)
b) axial coordinate X_{P}:
X_{P}=s−(1/(1+T²))+((s−(1−s)T²)(1−Kg(T)))/(s(1+T²)²);
a secondary reflective surface having an apex and a second shape described by:
a) radial coordinate R_{S}:
R_{S}=(2sKTg(T))/(s−(1−s)T²+KT²g(T))
b) axial coordinate X_{S}:
X_{S}=−(sK(1−T²)g(T))/(s−(1−s)T²+KT²g(T)); and
wherein the optical system includes a focus positioned along an optical axis and wherein T=tan(φ/2), g(T)=|1−((1−s)T²/s)|^{-s/(1-s)}, φ is an angle between the optical axis and a light ray extending between the focus and the secondary reflective surface when the light ray forms the largest cone of meridional rays than can enter or leave the optical system, s is the distance between the apex of the primary reflective surface and the apex of the secondary reflective surface, and K is the distance between the focus and the apex of the secondary reflective surface.

2. The imaging optical system of claim 1, wherein the focus is substantially coincident with the apex of the primary reflective surface.

3. The imaging optical system of claim 1, wherein the focus is between the primary and secondary reflective surfaces.

4. The imaging optical system of claim 1, wherein the focus is on an opposite side of the primary reflective surface in relation to the secondary reflective surface.

5. The imaging optical system of claim 1, wherein the primary reflective surface has a first rim, wherein the secondary reflective surface has a second rim, and wherein at least portions of the first rim and the second rim are substantially coplanar.

6. The imaging optical system of claim 1, wherein the primary reflective surface has a first rim, wherein the secondary reflective surface has a second rim, and wherein at least portions of the first rim and the second rim are not substantially coplanar.

7. The imaging optical system of claim 1, wherein the system functions to concentrate radiation being emitted onto the system.

8. The imaging optical system of claim 7, further comprising a radiation conduit, and wherein the focus is substantially at an entrance to the radiation conduit.

9. The imaging optical system of claim 8, wherein the radiation conduit is an optical rod or an optical fiber.

10. The imaging optical system of claim 8, further comprising an energy conversion device in communication with the radiation conduit.

11. The imaging optical system of claim 10, wherein the energy conversion device is a photovoltaic cell.

12. The imaging optical system of claim 1, wherein the system functions to collimate and emit radiation.

13. The imaging optical system of claim 12, wherein the radiation is generated by a quasi-lambertian source.

14. The imaging optical system of claim 13, wherein the quasi-lambertian source is a light-emitting diode.

15. The imaging optical system of claim 7, wherein the system includes an entrance numerical aperture and an exit numerical aperture, the entrance numerical aperture being from about 0.005 to about 0.1, while the exit numerical aperture being from about 0.2 to about 1.0.

16. An image optical system comprising:
a primary reflective surface having a concave shape, the primary reflective surface defining an apex, a vertical axis, and a rim;
a secondary reflective surface spaced from the primary reflective surface, the secondary reflective surface having a curved surface and having a vertical axis that is coincident with the vertical axis of the primary reflective surface, the secondary reflective surface having an apex and a rim, the secondary reflective surface defining a top surface comprising either the apex or the rim of the secondary reflective surface, the top surface of the secondary reflective surface being substantially coplanar with the rim of the primary reflective surface;
wherein the secondary reflective surface is positioned with respect to the primary reflective surface so as to create a focus located below the secondary reflective surface along the vertical axis; and
a substantially transparent plate attached to the rim of the primary reflective surface and to the top surface of the secondary reflective surface.

17. The imaging optical system of claim 16, wherein the secondary reflective surface has a convex shape and wherein the top surface of the secondary reflective surface comprises the rim.

18. The imaging optical system of claim 16, wherein the secondary reflective surface has a concave shape and wherein the top surface of the secondary reflective surface is the apex.

19. The imaging optical system of claim 16, wherein the focus is substantially coincident with the apex of the primary reflective surface.

20. The imaging optical system of claim 16, wherein the focus is between the primary and secondary reflective surfaces.

21. The imaging optical system of claim 16, wherein the focus is on an opposite side of the primary reflective surface in relation to the secondary reflective surface.

22. The imaging optical system of claim 16, wherein the system functions to concentrate radiation being emitted onto the system, the optical system further comprising a radiation conduit and wherein the focus is substantially at an entrance to the radiation conduit.

23. The imaging optical system of claim 22, further comprising an energy conversion device in communication with the radiation conduit, the energy conversion device comprising a photovoltaic cell.

24. The imaging optical system of claim 16, wherein the system functions to collimate and emit radiation.

25. The imaging optical system of claim 16, wherein the primary reflective surface has a shape defined by:
a) radial coordinate R_{P}:
R_{P}=2T/(1+T²)
b) axial coordinate X_{P}:
X_{P}=s−(1/(1+T²))+((s−(1−s)T²)(1−Kg(T)))/(s(1+T²)²);
and wherein the secondary reflective surface has a shape defined by:
a) radial coordinate R_{S}:
R_{S}=(2sKTg(T))/(s−(1−s)T²+KT²g(T))
b) axial coordinate X_{S}:
X_{S}=−(sK(1−T²)g(T))/(s−(1−s)T²+KT²g(T)); and
wherein T=tan(φ/2), g(T)=|1−((1−s)T²/s)|−s/^{(1-s)}, φ is an angle between an optical axis and a light ray extending between the focus and the secondary reflective surface when the light ray forms the largest cone of meridional rays that can enter or leave the optical system, s is the distance between the apex of the primary reflective surface and the apex of the secondary reflective surface, and K is the distance between the focus and the apex of the secondary reflective surface.

26. A solar cell comprising:
a photovoltaic cell; and
an optical system comprising,
a) a primary reflective surface having a concave shape, the primary reflective surface defining an apex, a vertical axis and a rim;
b) a secondary reflective surface spaced from the primary reflective surface, the secondary reflective surface having a curved surface and having a vertical axis that is coincident with the vertical axis of the primary reflective surface, the secondary reflective surface having an apex and a rim, the secondary reflective surface defining a top surface that comprises either the apex or the rim, the top surface of the secondary reflective surface being substantially coplanar with the rim of the primary reflective surface and wherein the secondary reflective surface is positioned with respect to the primary reflective surface so as to create a focus located below the secondary reflective surface along the vertical axis; and
c) a radiation conduit for receiving radiation being concentrated by the primary reflective surface and the secondary reflective surface, the radiation conduit being positioned along the vertex and having an entrance located substantially at the focus, the radiation conduit being in communication with the photovoltaic cell; and
wherein the optical system has an entrance numerical aperture and an exit numerical aperture, the entrance numerical aperture being from about 0.005 to about 0.1 and the exit numerical aperture being from about 0.2 to about 1.0.

27. A solar cell as defined in claim 26, wherein the primary reflective surface has a shape defined by:
a) radial coordinate R_{P}:
R_{P}=2T/(1+T²)
b) axial coordinate X_{P}:
X_{P}=s−(1/(1+T²))+((s−(1−s)T²)(1−Kg(T)))/(s(1+T²)²);
and wherein the secondary reflective surface has a shape defined by:
a) radial coordinate R_{S}:
R_{S}=(2sKTg(T))/(s−(1−s)T²+KT²g(T))
b) axial coordinate X_{S}:
X_{S}=−(sK(1−T²)g(T))/(s−(1−s)T²+KT²g(T)); and
wherein T=tan(φ/2), g(T)=|1−((1−s)T²/s)|^{-s/(1-s)}, φ is an angle between an optical axis and a light ray extending between the focus and the secondary reflective surface when the light ray forms the largest cone of meridional rays that can enter or leave the optical system, s is the distance between the apex of the primary reflective surface and the apex of the secondary reflective surface, and K is the distance between the focus and the apex of the secondary reflective surface.

28. A solar cell as defined in claim 26, wherein the focus is between the primary and secondary reflective surfaces.

29. A solar cell as defined in claim 26, wherein the secondary reflective surface has a convex shape and wherein the top surface of the secondary reflective surface comprises the rim.

30. A solar cell as defined in claim 27, wherein the primary reflective surface has a diameter of from about 10 mm to about 1000 mm and the secondary reflective surface has a diameter of from about 3 mm to about 100 mm.

31. An illumination device comprising:
a power source;
a light source in communication with the power source; and
an optical system surrounding the light source, the optical system comprising:
a) a primary reflective surface having a concave shape, the primary reflective surface defining an apex, a vertical axis and a rim;
b) a secondary reflective surface spaced from the primary reflective surface, the secondary reflective surface having a curved surface and having a vertical axis that is coincident with the vertical axis of the primary reflective surface, the secondary reflective surface having an apex and a rim, the secondary reflective surface defining a top surface that comprises either the apex or the rim, the top surface of the secondary reflective surface being substantially coplanar with the rim of the primary reflective surface, wherein the secondary reflective surface is positioned with respect to the primary reflective surface so as to create a focus located substantially where the light source is positioned, the light source being positioned in between the secondary reflective surface and the primary reflective surface along the vertical axis.

32. An illumination device in claim 31, wherein the primary reflective surface has a shape defined by:
a) radial coordinate R_{P}:
R_{P}=2T/(1+T²)
b) axial coordinate X_{P}:
X_{P}=s−(1/(1+T²))+((s−(1−s)T²)(1−Kg(T)))/(s(1+T²)²);
and wherein the secondary reflective surface has a shape defined by:
a) radial coordinate R_{S}:
R_{S}=(2sKTg(T))/(s−(1−s)T²+KT²g(T))
b) axial coordinate Xs:
X_{S}=−(sK(1−T²)g(T))/(s−(1−s)T²+KT²g(T)); and
wherein T=tan(φ/2), g(T)=|1−((1−s)T²/s)|^{-s/(1-s)}, φ is an angle between an optical axis and a light ray extending between the focus and the secondary reflective surface when the light ray forms the largest cone of meridional rays that can enter or leave the optical system, s is the distance between the apex of the primary reflective surface and the apex of the secondary reflective surface, and K is the distance between the focus and the apex of the secondary reflective surface.

33. An illumination device as defined in claim 31, wherein the secondary reflective surface has a convex shape.

34. An illumination device as defined in claim 31, wherein the light source comprises a quasi-lambertian source.

35. An illumination device as defined in claim 31, wherein the power source comprises one or more batteries.
